(19) United States
(12) Patent Application Publication
(10) Pub. No.: US 2026/0329005 A1
(43) Pub. Date: Oct. 22, 2026

(54) 90-DEGREE VERTICAL OPTICAL WAVEGUIDE BENDS AND SPLITTERS

(71) Applicant: UNIVERSITY OF MASSACHUSETTS, Westborough, MA (US)

(72) Inventor: Amir Arbabi, Westfield, MA (US)

(21) Appl. No.: 19/650,755

(22) Filed: Apr. 17, 2026

Related U.S. Application Data
(60) Provisional application No. 63/790,424, filed on Apr. 17, 2025.

(51) Int. Cl. G02B 6/125; G02B 6/12

(52) U.S. Cl. CPC G02B 6/125; G02B 6/12007; G02B 2006/12104; G02B 2006/1215

(57) ABSTRACT

The present disclosure presents a 90-degree vertical optical waveguide apparatuses and related methods. One such apparatus comprises an optical waveguide in the plane of a chip; an in-plane waveguide mirror that terminates the optical waveguide and has a reflectance higher than 70%; and a vertical optical waveguide, having an axis perpendicular to the plane of the chip, built into the chip and located upstream of the in-plane waveguide mirror.

### CROSS-REFERENCE TO RELATED APPLICATION

This application claims priority to co-pending U.S. provisional application entitled, “90-Degree Vertical Optical Waveguide Bends and Splitters,” having application number 63/790,424, filed Apr. 17, 2025, which is entirely incorporated herein by reference.

### BACKGROUND

Photonic integrated circuits (photonic chips) are optical circuits and components that are fabricated on planar semiconductor or dielectric substrates and are used for generating, routing, processing, and detecting optical signals. They are composed of optical waveguides that transmit and route optical signals in the plane of the chip, and have applications in telecommunications, short-range communications in data centers, optical sensors, optical quantum computing, and optical AI accelerators.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a side view of a 90-degree vertical waveguide bend apparatus in accordance with various embodiments of the present disclosure.

FIG. 2 shows a perspective view of a 90-degree vertical waveguide bend apparatus in accordance with various embodiments of the present disclosure.

FIGS. 3 and 4 show top views of a waveguide mirror designed using topology optimization in accordance with various embodiments of the present disclosure.

FIG. 5 shows an Efficiency versus Wavelength chart for the embodiment of the apparatus shown in FIG. 1.

FIGS. 6 and 7 show side views of optical intensity distribution simulation results at a wavelength of 1550 nm and 1600 nm, respectively, for the embodiment of the apparatus shown in FIG. 1.

FIG. 8 shows a side view of the electrical field distribution at a wavelength of 1550 nm for two back-to-back 90-degree vertical waveguide bends according to the embodiment of the apparatus shown in FIG. 1.

FIG. 9 is a chart showing an Efficiency of a 90-degree vertical waveguide bend versus random fabrication-induced dimensional errors for the embodiment of the apparatus shown in FIG. 1.

FIG. 10 illustrates an alternative embodiment of a 90-degree vertical waveguide bend apparatus in accordance with various embodiments of the present disclosure.

FIG. 11 shows an Efficiency versus Wavelength chart for the embodiment of the apparatus shown in FIG. 10.

FIG. 12 shows a side view of the electrical field distribution at a wavelength of 1550 nm for the embodiment of the apparatus shown in FIG. 10.

FIGS. 13-15 show side views of optical intensity distribution at a wavelength of 1500 nm, 1550nm, and 1600 nm, respectively, for the embodiment of the apparatus shown in FIG. 10.

FIGS. 16 and 17 illustrate alternative embodiments of a vertical waveguide splitter apparatus in accordance with various embodiments of the present disclosure.

### DETAILED DESCRIPTION

The present disclosure presents systems and related methods for optical waveguide structures.

Coupling light efficiently in and out of photonic integrated circuits or chips and 2.5D and 3D integration of photonic chips is a significant challenge, especially when a high density of connections is required. In contrast to electronic chips that utilize multilayer copper interconnects for inter-chip and high-density connections via technologies such as through-silicon vias and ball grid arrays for intra-chip connections, photonic chips lack such connection interfaces.

In accordance with the present disclosure, a novel design for 90-degree optical waveguide bend apparatuses (“bends”) 100 that enable directing light out of the plane of a photonic chip is presented. The disclosed 90-degree vertical bends address this issue by enabling highly efficient, wideband (more than 100 nm 3dB bandwidth) connections through the surface of photonic chips at a high density (pitch smaller than 10 µm) and low crosstalk. The bends 100 are compatible with the silicon photonic foundry processes.

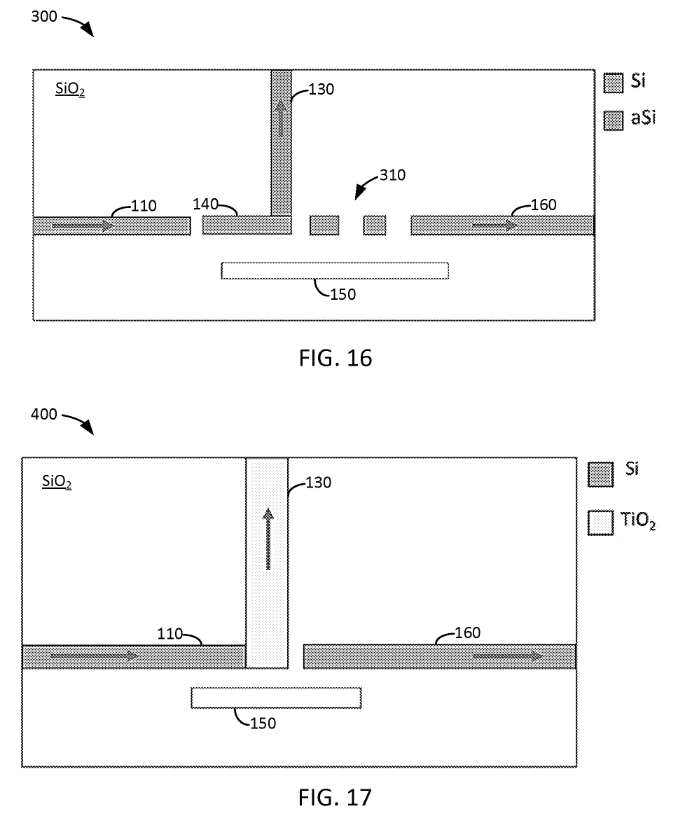

In various embodiments, a vertical 90-degree optical waveguide bend 100 includes an SiO₂ substrate 105, in-plane waveguide 110 (e.g., Si waveguide, Si₃N₄ waveguide), a lithographically patterned waveguide mirror 120 (e.g., Si waveguide mirror, Si₃N₄ waveguide), an integrated vertical optical waveguide 130 (e.g., amorphous Silicon (aSi) optical waveguide, Si waveguide), an optional impedance matching section 140 (e.g., Si waveguide, Si₃N₄ waveguide), an optional planar reflector 150 (e.g., Al reflector or other type of metallic layer reflector) under the bend, and an optional in-plane output waveguide 160 (FIG. 16) (e.g., Si waveguide, Si₃N₄ waveguide). In various examples, a 3D structure of the bend 100 can be optimized using the adjoint technique either as a parameterized structure or as a starting point for freeform optimization. Accordingly, in various embodiments, the waveguide mirror 120 and the impedance matching section 140 is designed using shape optimization or parameterized optimization. Different example embodiments of the disclosed 90-degree vertical bends and their results are presented in the following figures.

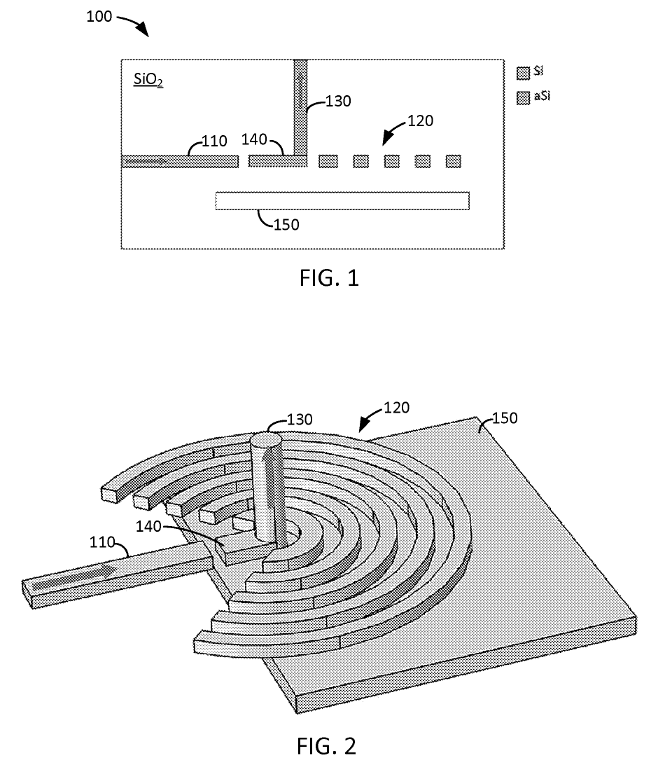

FIG. 1 shows a side view of a 90-degree vertical waveguide bend 100, according to an example embodiment. The plane of the chip is along the horizontal direction, and the arrows show the direction of light flow. As shown in FIG. 1, the device 100 is composed of an in-plane waveguide 110, a waveguide mirror 120 at the end of the in-plane waveguide 110, a vertical waveguide 130 that is normal to the plane of the chip and connects to the in-plane waveguide 110 at a location downstream of the waveguide mirror 120. The device can potentially include an impedance matching section 140 before or upstream the vertical waveguide’s connection point to reduce the reflection from the bend and the device loss. It can also potentially include a reflector 150 (e.g., an aluminum layer) underneath the device area to reduce the radiation loss into the lower cladding/substrate. The addition of another in-plane waveguide 160 and reducing the waveguide mirror’s reflectance render the device into a vertical splitter 300, 400 as shown in FIGS. 16 and 17.

In various non-limiting embodiments, an exemplary bend apparatus 100 comprises a photonic integrated circuit (chip) that features an on-chip footprint smaller than 10 µm by 10 µm comprising: an optical waveguide 110 in the plane of a chip; an in-plane waveguide mirror 120 formed by lithographic patterning that terminates the in-plane waveguide 110 and has a reflectance higher than 70%; and a vertical optical waveguide 130, having an axis perpendicular to the plane of the chip, built into the chip and located upstream of the mirror 120, with its bottom base positioned no more than 0.5 µm above the base of the in-plane waveguide 110. Additionally, in various embodiments, the waveguides 110, 130 and mirror 120 are encapsulated in a material with a refractive index smaller than 1.6; the waveguides are single-mode; the vertical waveguide’s cross-section is rectangular; the vertical waveguide’s cross-section is circular; the refractive index of the vertical waveguide 130 is between 1.4 and 3.6; the vertical waveguide is made of amorphous silicon, silicon, titanium dioxide, or polymeric material; different portions of the in-plane waveguide 110 and mirror 120 are etched to different depths; and/or the waveguide mirror 120 is a distributed Bragg reflector (e.g., a multi-layer dielectric Bragg reflector).

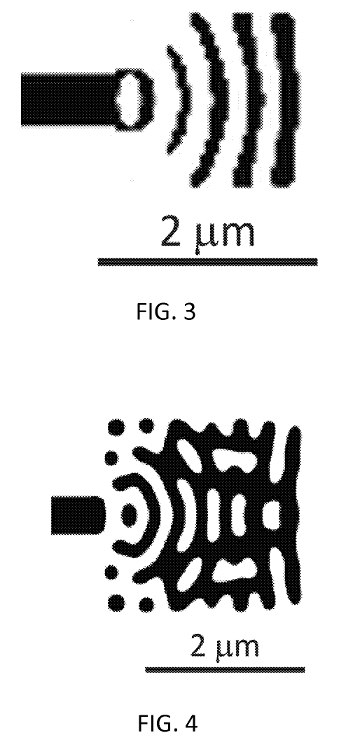

Next, FIG. 2 shows a perspective view of a 90-degree vertical waveguide bend 100, according to another example embodiment. The waveguide mirror 120 in this embodiment comprises a set of annular rings. The depicted arrows show the direction of light flow. Correspondingly, FIG. 3 shows a top view of a waveguide mirror 120, according to another example embodiment, where the mirror 120 is designed using topology optimization; and FIG. 4 shows a top view of a waveguide mirror 120, according to another example embodiment, where the mirror 120 is designed using topology optimization.

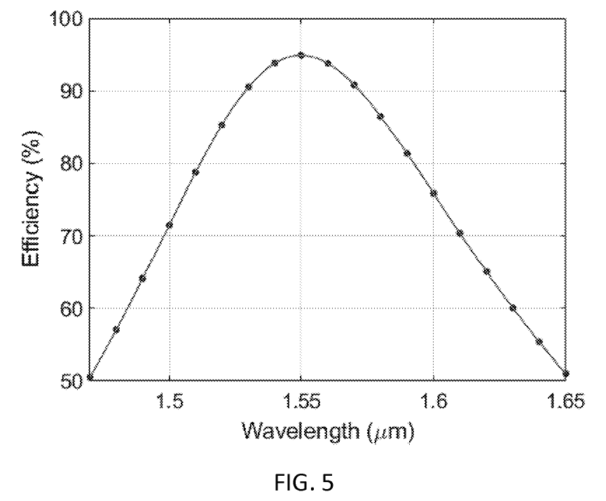

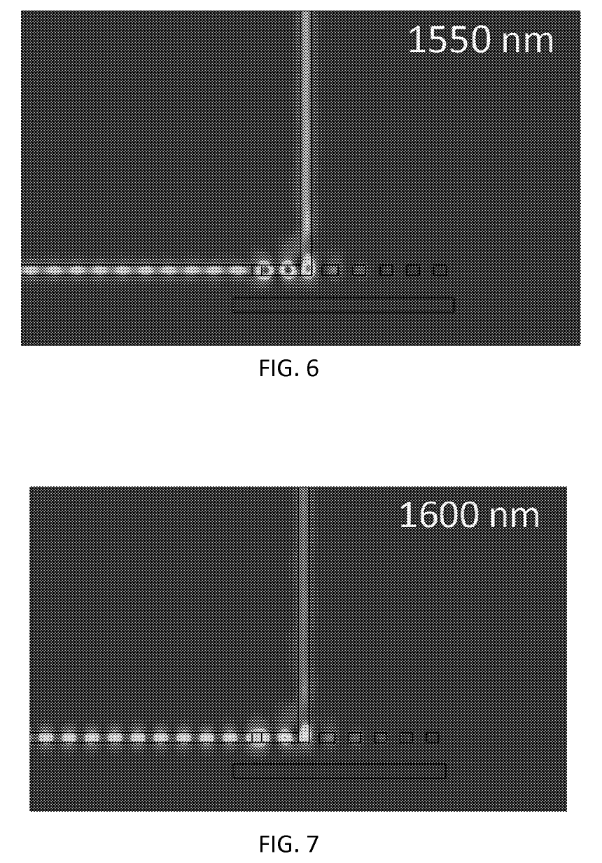

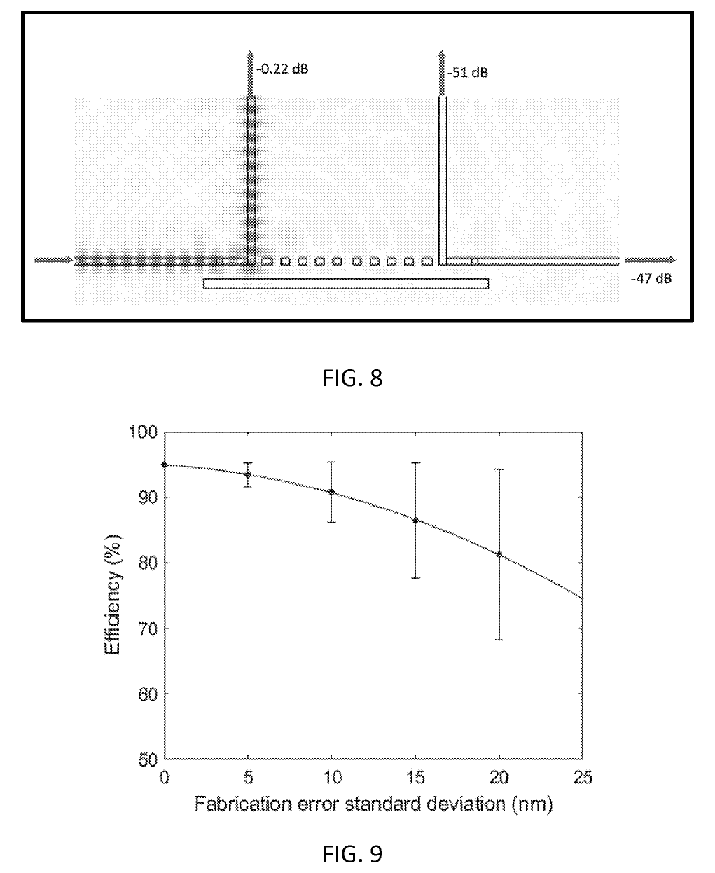

In considering performance results of tested bends 100, FIG. 5 shows an Efficiency versus Wavelength chart for the embodiment shown in FIG. 1. Here, coupling efficiency is defined as the portion or percentage of the power in the in-plane waveguide that is directed to the vertical waveguide. Additionally, FIG. 6 shows a side view of optical intensity distribution simulation results at a wavelength of 1550 nm for the embodiment shown in FIG. 1. A coupling efficiency of 95% (-0.22 dB loss) was achieved. Correspondingly, FIG. 7 (FIG. 8) shows a side view of optical intensity distribution at a wavelength of 1600 nm for the embodiment shown in FIG. 1. FIG. 8 shows a side view of the electrical field distribution at a wavelength of 1550 nm for two back-to-back 90-degree vertical waveguide bends according to the embodiment shown in FIG. 1. The results show low crosstalk between bends at a pitch of 3µm. FIG. 9 depicts the Efficiency of a 90-degree vertical waveguide bend versus random fabrication-induced dimensional errors for the embodiment shown in FIG. 1, where the coupling efficiency is defined as the portion of the power in the in-plane waveguide that is directed to the vertical waveguide at the wavelength of 1550 nm. The results show the robustness of the device to fabrication errors. From the performance results, it may be observed that the exemplary design is non-resonant (Q~8) and has low radiation loss; its 1.5 dB bandwidth is 120nm; and efficiency drop at other wavelengths is due to reflection and the bandwidth can be further increased by using a two-gap matching network.

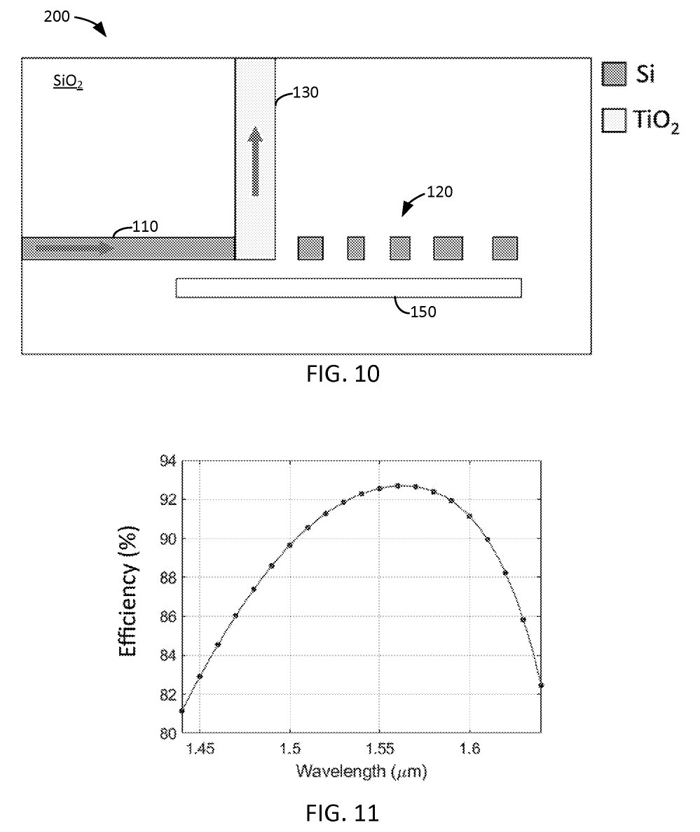

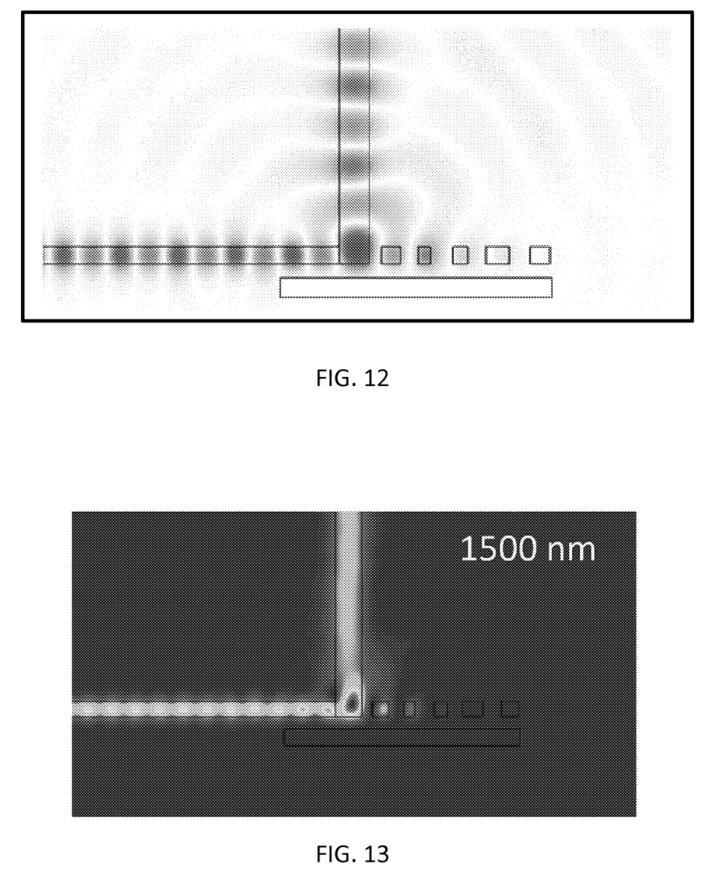

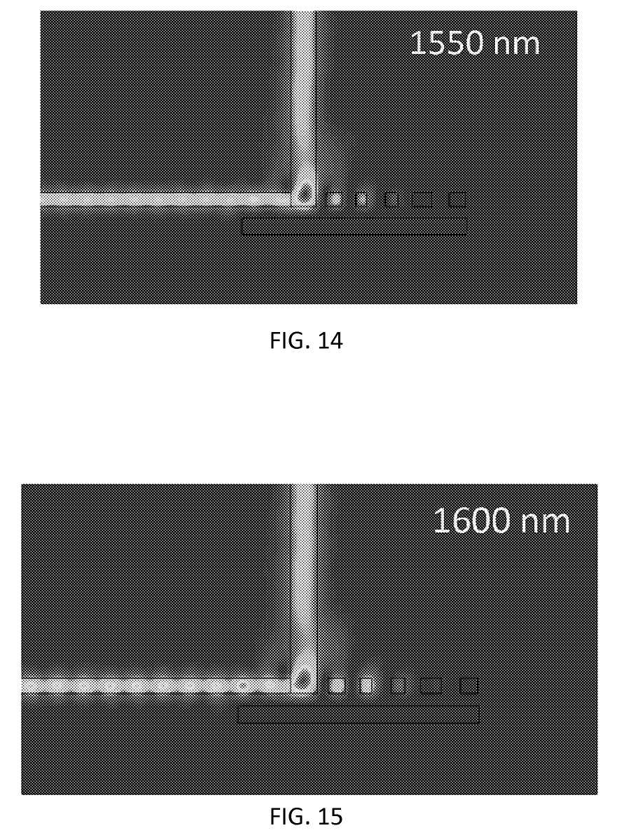

In accordance with various embodiments, FIG. 10 illustrates an alternative embodiment of a bend apparatus 200, where the plane of the chip is along the horizontal direction and the depicted arrows show the direction of light flow. In this non-limiting example, the reflector 150 is 2.8µm in length. In this embodiment, the vertical waveguide 130 structure is a TiO₂ waveguide. Correspondingly, FIG. 11 shows Efficiency versus wavelength for the embodiment shown in FIG. 10, where coupling efficiency is defined as the portion of the power in the in-plane waveguide that is directed to the vertical waveguide. In turn, FIG. 12 shows a side view of the electrical field distribution at a wavelength of 1550 nm for the embodiment shown in FIG. 10. FIG. 13 shows a side view of optical intensity distribution at a wavelength of 1500 nm for the embodiment shown in FIG. 10. FIG. 14 shows a side view of optical intensity distribution at a wavelength of 1550 nm for the embodiment shown in FIG. 10. FIG. 15 shows a side view of optical intensity distribution at a wavelength of 1600nm for the embodiment shown in FIG. 10. From the performance results, it may be observed that the exemplary design is non-resonant (Q~5) and has low radiation loss; and its coupling efficiency is better than -1 dB over 200nm bandwidth.

In accordance with various alternative embodiments, FIG. 16 (FIG. 17) illustrates an embodiment of a vertical waveguide splitter apparatus 300, where the plane of the photonic chip is along the horizontal direction, and the depicted arrows show the direction of light flow. In various embodiments, a vertical waveguide splitter 300 includes an SiO₂ substrate, an in-plane waveguide 110 (e.g., Si waveguide, Si₃N₄ waveguide), a lithographically patterned partial waveguide mirror 310 (e.g., Si waveguide mirror, Si₃N₄ waveguide mirror), an integrated vertical optical waveguide 130 (e.g., amorphous Silicon (aSi) optical waveguide, Si waveguide), an optional impedance matching section 140 (e.g., Si waveguide, Si₃N₄ waveguide), an optional planar reflector 150 (e.g., Al reflector or other type of metallic layer reflector) under the bend, and an optional in-plane output waveguide 160 (e.g., Si waveguide, Si₃N₄ waveguide). The addition of another in-plane waveguide 160 and reducing the reflectance of the waveguide mirror (via partial mirror 310) render the device into a vertical splitter 300.

Next, FIG. 17 shows an alternative embodiment of an exemplary vertical waveguide splitter according to another non-limiting example of the present disclosure. Here, a side view of a vertical waveguide splitter 400 is presented, with the plane of the photonic chip being along the horizontal direction and the depicted arrows showing the direction of light flow. . In various embodiments, a vertical waveguide splitter 400 includes an SiO₂ substrate, in-plane waveguide 110 (e.g., Si waveguide, Si₃N₄ waveguide), an integrated vertical optical waveguide 130 (e.g., TiO₂ optical waveguide), an optional reflector 150 (e.g., Al reflector) under the bend, and an in-plane output waveguide 160 (e.g., Si waveguide, Si₃N₄ waveguide). The addition of another in-plane waveguide 160 and removal of the waveguide mirror 120/310 render the device into a vertical splitter 400.

In various non-limiting embodiments, an exemplary splitter apparatus 300, 400 comprises a photonic integrated circuit (chip) that features an on-chip footprint smaller than 10 µm by 10 µm comprising: an input optical waveguide 110 in the plane of a chip; an output optical waveguide 160 in the plane of the chip; a partial waveguide mirror 310 formed by lithographic patterning that is located between the input and output in-plane optical waveguides 110, 160; and a vertical optical waveguide 130 having an axis perpendicular to the plane of the chip, built into the chip and positioned between the input and output in-plane optical waveguides 110, 160, with its bottom base positioned no more than 0.5 µm above the base of the in-plane waveguides. Additionally, in various embodiments, the waveguides 110, 130, 160 and mirror 120 are encapsulated in a material with a refractive index smaller than 1.6; the waveguides are single-mode; the vertical waveguide’s cross-section is rectangular; the vertical waveguide’s cross-section is circular; the refractive index of the vertical waveguide 130 is between 1.4 and 3.6; the vertical waveguide is made of amorphous silicon, silicon, titanium dioxide, or polymeric material; different portions of the in-plane waveguide 110 and mirror 120 are etched to different depths; and/or the waveguide mirror 120 is a distributed Bragg reflector (e.g., a multi-layer dielectric Bragg reflector).

Compared to the state-of-the-art approaches for coupling to vertical waveguides, an exemplary design of the 90-degree vertical waveguide bend 100 (FIG. 1) can have a 1000 times smaller footprint (e.g., as small as 3µm by 3µm versus 100µm by 100 µm), provide lower loss, and be compatible with standard binary lithography used in silicon photonics foundry processes allowing for their large scale fabrication.

Main applications of the disclosed bend include co-packaged optics, 3D integrated photonic chips, heterogeneously integrated photonic chips, LiDARs, optical phased arrays, optical artificial intelligence (AI) accelerators, free space optical transceivers, and high-speed photonic integrated circuits for fiber optic communications.

Compared to techniques based on micro-optical components like 45-degree mirrors (either off-chip or directly written on chip using the photon polymerization process) and grating couplers, the disclosed bend has a significantly smaller footprint and enables a higher density of interconnects and emitters. Furthermore, the micro-optical components require one-by-one alignment of the elements, and the two-photon polymerization is slow and serial process. The grating coupling approach has low efficiency and limited bandwidth.

In addition to routing light vertical to the plane of the chip direct chip to chip communication, chip to interposer connection, and chip to fiber connection, the bends 100 can also be utilized as vertical emitters (e.g., FIGS. 16 and 17) by using short vertical waveguides or as vertical splitters by using a partially reflecting waveguide mirrors and adding a second in-plane waveguide that carries the portion of the light transmitted through the partial waveguide mirror.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It is also to be understood that the terminology used herein is for purposes of describing particular embodiments only, and is not intended to be limiting. Unless defined otherwise, all technical and scientific terms used herein have the same meanings as commonly understood by one of skill in the art to which the disclosed invention belongs.

It must be noted that, as used in the specification and the appended claims, the singular forms “a,” “an,” and “the” include plural referents unless the context clearly dictates otherwise.

Those skilled in the art will recognize, or be able to ascertain using no more than routine experimentation, many equivalents to the specific embodiments of the invention described herein. Such equivalents are intended to be encompassed by the following claims.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

What is claimed is:

1. A 90-degree vertical optical waveguide bend (VWB) apparatus comprising:
an optical waveguide in the plane of a chip;
an in-plane waveguide mirror that terminates the optical waveguide and has a reflectance higher than 70%; and
a vertical optical waveguide, having an axis perpendicular to the plane of the chip, built into the chip and located upstream of the in-plane waveguide mirror.

2. The apparatus of claim 1, wherein a bottom base of the in-plane waveguide mirror is positioned no more than 0.5 µm above a base of the optical waveguide, wherein an on-chip footprint of the apparatus is smaller than 10 µm by 10 µm.

3. The apparatus of claim 1, wherein the optical waveguide, the vertical optical waveguide, and the in-plane waveguide mirror are encapsulated in a material with a refractive index smaller than 1.6.

4. The apparatus of claim 1, wherein the optical waveguide and the in-plane waveguide mirror are made of silicon or silicon nitride (Si₃N₄).

5. The apparatus of claim 1, wherein the optical waveguide and the vertical optical waveguide are single-mode.

6. The apparatus of claim 1, wherein a refractive index of the vertical optical waveguide is between 1.4 and 3.6.

7. The apparatus of claim 1, wherein the vertical optical waveguide is made of amorphous silicon, silicon, titanium dioxide, a polymeric material.

8. The apparatus of claim 1, wherein different portions of the optical waveguide and the in-plane waveguide mirror are etched to different depths.

9. The apparatus of claim 1, wherein the in-plane waveguide mirror is a distributed Bragg reflector.

10. The apparatus of claim 1, further comprising a planar reflector under a portion of the optical waveguide and the in-plane waveguide mirror.

11. The apparatus of claim 1, further comprising an impedance matching section located upstream of the vertical optical waveguide’s location.

12. A 90-degree vertical optical waveguide splitter (VWS) apparatus comprising:
an input optical waveguide in the plane of a chip;
an output optical waveguide in the plane of the chip;
a partial waveguide mirror that is located between the input and output in-plane optical waveguides; and
a vertical optical waveguide having an axis perpendicular to the plane of the chip, wherein the vertical optical waveguide is built into the chip and is positioned between the input and output in-plane optical waveguides, with its bottom base positioned no more than 0.5 µm above a base of the input and output optical waveguides.

13. The apparatus of claim 12, wherein an on-chip footprint of the apparatus is smaller than 10 µm by 10 µm.

14. The apparatus of claim 12, wherein the input optical waveguide, the output optical waveguide, and the partial waveguide mirror are encapsulated in a material with a refractive index smaller than 1.6.

15. The apparatus of claim 12, wherein the input optical waveguide, the output optical waveguide, and the partial waveguide mirror are made of silicon or silicon nitride.

16. The apparatus of claim 12, wherein a refractive index of the vertical optical waveguide is between 1.4 and 3.6.

17. The apparatus of claim 12, wherein the vertical optical waveguide is made of amorphous silicon, silicon, titanium dioxide, or a polymeric material.

18. The apparatus of claim 12, wherein different portions of the input optical waveguide, the output optical waveguide, and the partial waveguide mirror are etched to different depths.

19. The apparatus of claim 12, further comprising a planar reflector under a portion of the output optical waveguide and the partial waveguide mirror.

20. The apparatus of claim 12, further comprising an impedance matching section that is located upstream of the vertical optical waveguide’s location.
